(19) United States
(12) Patent Application Publication
(10) Pub. No.: US 2005/0185402 A1
(43) Pub. Date: Aug. 25, 2005

(54) Night lamp with varicolored lamp shield

(76) Inventor: Fu-Hsien Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/784,294

(22) Filed: Feb. 24, 2004

(51) Int. Cl. F21V 33/00

(52) U.S. Cl. 362/257

(57) ABSTRACT

A night lamp with varicolored lamp shield includes a light bulb, a lamp shield, an optical fiber assembly and a lamp shade. The light bulb is screwed and electrically connected to a lamp holder of a plug for providing illumination. The lamp shield, made of light transmitting material, is formed with holes and rotatably supported on a top end of the light bulb. The lamp shield comprises a plurality of blades with gaps defined therebetween and a plurality of strips of different colors extending downward from the blades. The heat from the light bulb causes an uplift air stream which flows through the gaps and drives the lamp shield to rotate. The optical fiber assembly is mounted to a supporting rod of the lamp shade and includes a plate formed with a plurality of holes, from which a plurality of optical fibers is mounted and extend. The optical fiber assembly also includes a clip for fastening to the neck.

### BACKGROUND OF THE INVENTION

1. Field of the Invention

The present invention relates generally to a light-emitting device, and in particular to a night lamp with varicolored lamp shield.

2. Description of the Prior Art

Light-emitting device is an indispensable article for daily use. It is widely used for illumination, decoration, directive indication e.g. traffic lights, functional indication e.g. operation lights in electric appliances, and so on. Of the various functions, the primary function of light-emitting device is illumination.

Practically, lamp is equipped with beautiful lamp shade so that it can be used for illumination and decoration at the same time. There are a variety of lamps commercially available in the market. Lamps with various sizes, shapes, patterns and colors are designed. Moreover, some lamps include control circuits controlling the lamps to project in different manners or provide particular visual effect like flashing in Christmas light. Also, some lamps are designed with adjustable intensities so that they can be varied in accordance with the illumination requirement.

Of the various kinds of lamps, night lamp is a popular article. Conventionally, night lamp provides soft illumination, and it is primarily used as light source at night. Although night lamp generally has low light intensity, it provides sufficient illumination for the user to roughly view the surrounding at darkness. Generally, night lamp has simple structure and does not possess any function. Some night lamps may include sensors for detecting the light intensity of the surrounding. When the detected light intensities are lower than predetermined values, the sensors would automatically trigger the on/off of the light bulbs. Besides, most night lamps are provided with attractive lamp shades for decoration.

However, since night lamp is small in size and directly plugged to a power socket on wall, it is not easy to view the pattern of the lamp shade on the night lamp. Furthermore, each night lamp is commonly equipped with a single light bulb that is only capable to project light with specific color for example yellow. They do not enable variation of light color or provide changeable lighting effect. Currently, no night lamp in the market can provide multiple color lighting or changeable lighting. As a whole, the decorative pattern of the conventional night lamp is monotonous. It is known that multiple color lamps are developed for other types of lamps.

Take for an example. U.S. Pat. No. 6,483,439 discloses a multi color and omni directional warning lamp which can provide multi status indication by being illuminated in selected ones of a plurality of colors or by flashing a selected color or colors sequentially. The warning lamp comprises arrays of light emitting diodes (LEDs) disposed along spaced lines, which provide light of different color.

In U.S. Pat. No. 6,179,449, a multi-color semiconductor lamp and method of providing colored illumination is disclosed. The multi-color semiconductor lamp includes a semiconductor light source activable so as to generate a light output, a dispersing prism and a lens. The prism separates the light output of the light source into a plurality of chromatic components that radiate at different angles at the output side. By varying the prism, a selected one of the chromatic components is registered with the conical focusing region of the lens.

A lamp box with color variable light source is taught in U.S. Pat. No. 6,64,304. The lamp box comprises a metal halide lamp, a bowl-like reflector, a power source, a filter and a drive motor in its body. The body of the lamp box is connected with optical fibers through a fiber optic plug, so that the light source lamp box can change its color easily.

However, those prior arts include complicated structures and/or expensive accessories. They are either too big or too expensive to be used in night lamp. It is desired to provide a structure that enables a night lamp to generate varicolored lighting.

### SUMMARY OF THE INVENTION

Thus, a primary object of the present invention is to provide a night lamp with varicolored lamp shield that can provide varicolored lighting.

Another object of the invention is to provide a night lamp with removable lamp shield comprising blades. Heat from the light bulb causes an uplift air stream which flows through the gaps between blades and drives the lamp shield to rotate.

A further object of the invention is to provide a night lamp comprising a lamp shield rotatably supported on a top end of the light bulb. The lamp shield comprises a plurality of strips of different colors. Hence, light from the light bulb is transmitted through the lamp shield and changed into different colors.

A still further object of the invention is to provide a night lamp comprising an optical fiber assembly which includes a plurality of optical fibers for transmitting light from the light bulb and generating varicolored light spots on the lamp shade.

To achieve the above objects, in accordance with the present invention, there is provided a night lamp with varicolored lamp shield. The night lamp comprises a light bulb, a lamp shield, an optical fiber assembly and a lamp shade. The light bulb is screwed and electrically connected to a lamp holder of a plug for providing illumination. The lamp shield, made of light transmitting material, is formed with holes and rotatably supported on a top end of the light bulb. The lamp shield comprises a plurality of blades with gaps defined therebetween and a plurality of strips of different colors extending downward from the blades. The heat from the light bulb causes an uplift air stream which flows through the gaps and drives the lamp shield to rotate. The optical fiber assembly is mounted to a supporting rod of the lamp shade and includes a plate formed with a plurality of holes, from which a plurality of optical fibers is mounted and extend. The optical fiber assembly also includes a clip for fastening to the neck.

The present invention will be apparent to those skilled in the art by reading the following description of preferred embodiments thereof, with reference to the attached drawings, in which:

### BRIEF DESCRIPTION OF THE DRAWINGS

FIG. 1 is a rear perspective view of a night lamp with varicolored lamp shield constructed in accordance with a preferred embodiment of the present invention;

FIG. 2 is a rear exploded view of the night lamp of the present invention;

FIG. 3 is another exploded view of the night lamp of the present invention, in which an optical fiber assembly is further disassembled from the lamp shade;

FIG. 4 is partial exploded view of the night lamp of the present invention, in which a lamp shield is supported by a coil of the night lamp;

FIG. 5 is a front perspective view of the night lamp of the present invention, in which the lamp shade represented by dotted line is removed from the night lamp; and

FIG. 6 is a sectional view taken along line 6-6 of FIG. 1.

### DETAILED DESCRIPTION OF THE PREFERRED EMBODIMENTS

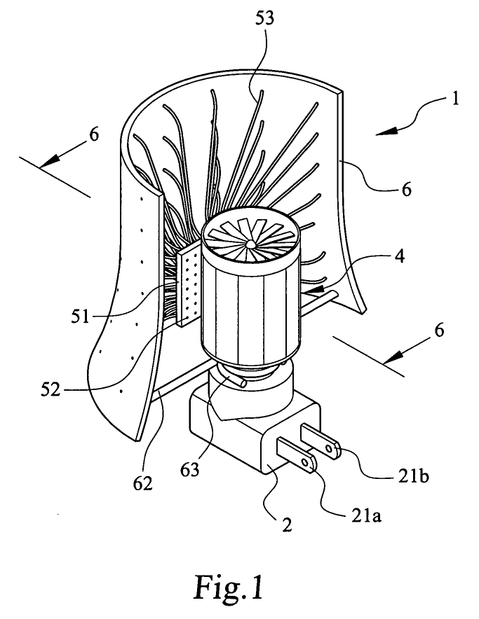

With reference to the drawings and in particular to FIGS. 1 to 3, a night lamp with varicolored lamp shield constructed in accordance with a preferred embodiment of the present invention is shown. The night lamp is generally designated with reference numeral 1, which comprises a plug 2, a light bulb 3, a lamp shield 4, an optical fiber assembly 5 and a lamp shade 6.

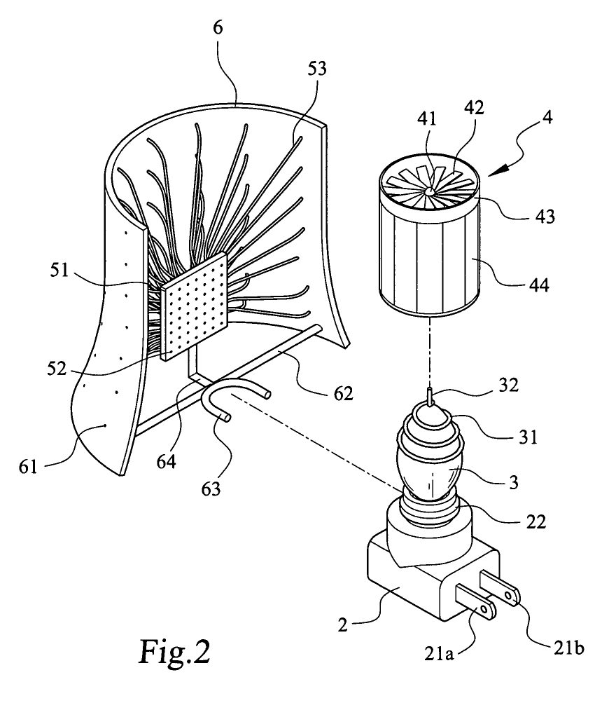

As shown in FIG. 2, which is a rear exploded view of the night lamp, a pair of pins 21a, 21b are extended from the plug 2 for plugging to a power source on wall for receiving power therefrom. The plug 2 is formed with a lamp holder (not labeled) for holding the light bulb 3 and supplying electricity to the light bulb 3. The lamp holder comprises a receptacle and a neck 22 protruded at a top of the plug 2. The light bulb 3 may be a conventional incandescent lamp for providing illumination.

A helical shape coil 31 is removably arranged at an upper part of the light bulb 3 and stably anchored to the light bulb 3. The coil 31 is made of heat resistant material for example metal that can withstand the high temperature at the surface of the light bulb 3. Moreover, an upper end of the coil 31 is bent upward to provide a tip 32 at a top end of the light bulb 3 for supporting the lamp shield 4.

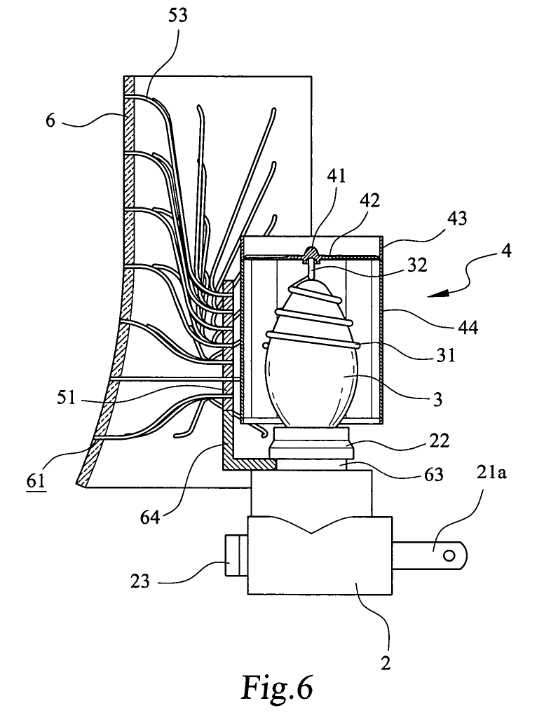

The lamp shield 4 is in the form of a hollow cylinder with an open lower end. The lamp shield 4 comprises a central collar 41, which can be rotatably supported at the tip 32 of the coil 31 in any suitable manner. For example, as shown in FIG. 6 which is a sectional view taken along line 6-6 of FIG. 1, a dimple (not label) is defined in an underside of the central collar 41 for receiving the tip 32 of the coil 31.

A plurality of blades 42 are radially extended from the collar 41. Outward ends (not labeled) of the blades 42 are fixed to a ring 43. Moreover, a plurality of strips 44 extend downward from the ring 43. Preferably, the lower ends of the strips 44 are fixed together by a lower ring. The strips 44 are made of light transmitting material and are selectively provided with different colors. All the components of the lamp shield 4 are made of heat resistant material.

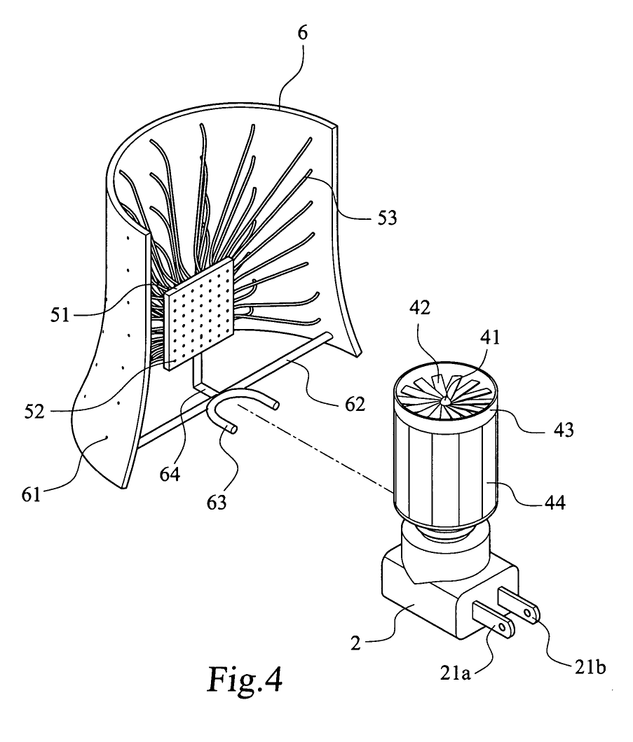

Please refer to FIG. 4 which a partial exploded view of the night lamp. When the lamp shield 4 is placed on the coil 31, the lamp shield 4 covers the whole light bulb 3, whereby light from the light bulb 3 transmitting through the strips 44 becomes light of different colors. When the light bulb 3 is turned on, besides light, the light bulb 3 gives off heat in a radiation form. The heat radiation raises the temperature of air in the lamp shield 4, and thereby causing an uplift air stream which flows through gaps (not labeled) between the blades 41 and induces a rotation of the blades 41. Accordingly, the lamp shield 4 is driven to rotate. As the lamp shield 4 is rotating, the color of the light transmitting through the lamp shield 4 is also changing.

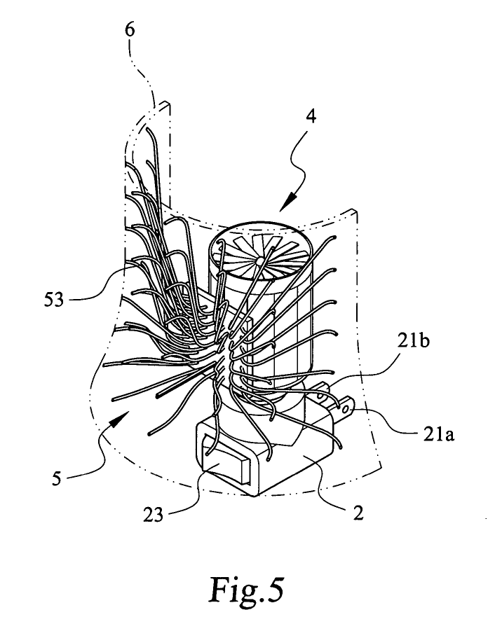

With reference to FIGS. 5 and 6, FIG. 5 shows a front perspective view of the night lamp, in which the lamp shade is removed, and FIG. 6 is the sectional view. A button 23 is provided at a front side of the plug 2 for turning on/off the light bulb 3. Alternatively, the night lamp 3 may include a sensor for detecting the light intensity of the surrounding and triggering the on/off of the light bulb 3 automatically when the detected light intensity is lower than a predetermined value.

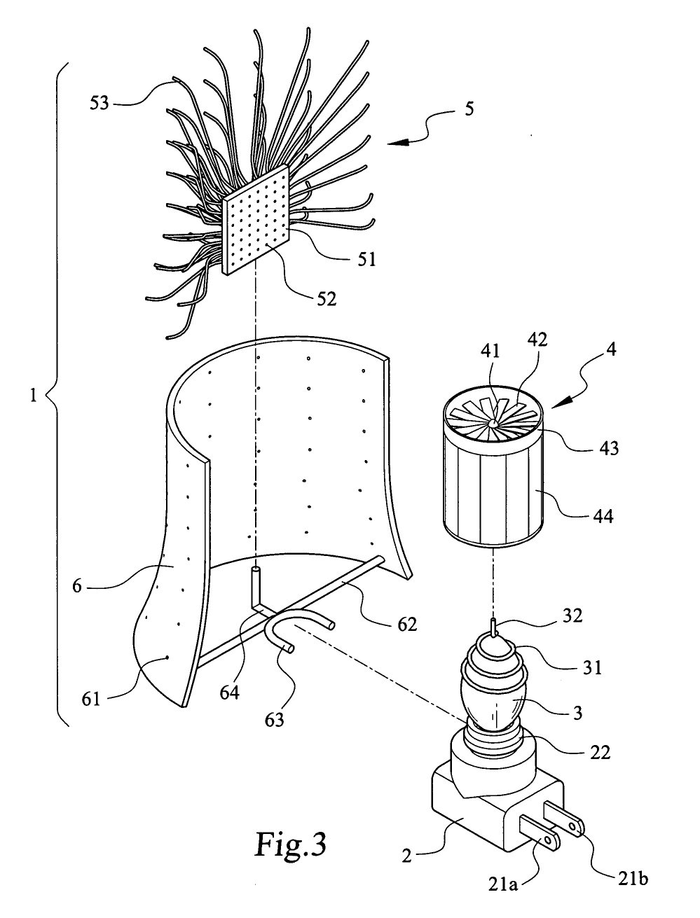

The optical fiber assembly 5 is arranged at a front side of the light bulb 3. The optical fiber assembly 5 comprises a plate 51 formed with a plurality of holes 52 and a plurality of optical fibers 53. Each of the optical fibers has a first end mounted to a hole 52 of the plate 51 and a second end mounted to a hole 61 of the lamp shade 6. It can be clearly seen from FIGS. 3 and 4 that the plate 51 is supported by a supporting rod 64 of the lamp shade 6. The optical fibers are capable to transmit light and form light spots at the front ends.

The lamp shade 6, which is adjacent to the light bulb 3, is made of light transmitting material and formed with a plurality of holes 61. A lateral rod 62 is formed at a lower part of the lamp shade 6. At a middle section of the lateral rod 62, there is provided with a U-shaped clip 63 with two forks (not labeled) extending rearward for fastening to the neck 22 of the plug 2. The lateral distance between the two forks is approximately the same as the diameter of the lower part of the neck 22. By pushing the clip 63 towards the lower part of the neck 22, the lamp shade 6 can be easily fastened to the neck 22.

As shown in FIG. 6, the lower part of the neck 22 has a smaller diameter than the upper part of the neck 22 and hence secures the fastening of the neck 22 by the clip 63. Both the lamp shield 4 and the lamp shade 6 can be simply removed from the night lamp 1, such that replacement of any components or maintenance of the night lamp 1 can be easily proceeded.

Moreover, the supporting rod 64 comprises a bent rod oppositely extending from the lateral rod 62 at a position corresponding to the clip 63. The lower side of the plate 51 of the optical fiber assembly 5 is mounted to an upper end of the supporting rod 64, such that the plate 51 is just supported by the supporting rod 64 and located in front of the light bulb 3 and lamp shield 4 as shown in FIG. 5.

The front ends of the optical fibers 52 of the optical fiber assembly 5 fit into the holes 61 on the lamp shade 6. At illumination, colorful light from the light bulb 1 transmits through the lamp shield 4 and projects on the plate 51 and the lamp shade 6. The light projected on the holes 52 of the plate 51 is transmitted by the optical fibers 53 to the front ends on the lamp shade 6, forming light spots of different colors. Since light from the rotating lamp shield 4 is continuously changing, the colors of the light spots are also changing, forming a very attractive pattern. Meanwhile, a part of the light is transmitted through the lamp shade 6 to illuminate the surrounding, providing a varicolored illumination.

The multiple color light spots and variable illumination generated by the night lamp provide fun to the users. For some children who are afraid of darkness, the night lamp with varicolored lamp shield would attract their attention and reduce their fear. The night lamp can also be applied as a decorative lamp for party.

Although the present invention has been described with reference to the preferred embodiments thereof, it is apparent to those skilled in the art that a variety of modifications and changes may be made without departing from the scope of the present invention which is intended to be defined by the appended claims.

1. A night lamp comprising:
a light bulb for projecting a light and generating an uplift air stream by heating air surrounding the light bulb;
a lamp shield, which is made of light transmitting material and rotatably supported on the light bulb, the lamp shield comprising a plurality of blades with gaps defined therebetween and a plurality of strips formed of light transmitting material and of different colors extending downward from the lamp shield, the lamp shield being driven by the uplift air stream flowing through the gaps to rotate;
a lamp shade arranged adjacent to the light bulb and formed with a plurality of holes; and
an optical fiber assembly supported between the lamp shade and the light bulb, comprising a plate which is formed with a plurality of holes and a plurality of optical fibers, each of the optical fibers having a first end mounted to a hole of the plate and a second end mounted to a hole of the lamp shade;
wherein the light projected from the light bulb projects a varicolored light through the rotating lamp shade and then the varicolored light is guided to the lamp shade through the optical fibers.

2. The night lamp as claimed in claim 1, wherein the lamp shield further comprises a central collar from which the blades extend.

3. The night lamp as claimed in claim 1, wherein the night lamp further comprises a coil for removably arranging on the top of the light bulb, an upper end of the coil being bent upward to provide a tip at a top end of the light bulb for supporting the lamp shield.

4. The night lamp as claimed in claim 1, wherein the lamp shade further comprises a lateral rod at a lower part of the lamp shade, a clip for fastening to the plug, and a supporting rod for supporting the plate of the optical fiber assembly.

5. The night lamp as claimed in claim 4, wherein the clip is U-shaped form and arranged at a middle section of the lateral rod with two forks extending rearward for securing to the neck of the plug.

6. The night lamp as claimed in claim 1, wherein the strips are made of heat resistant material.
